(19) United States
(12) Patent Application Publication
(10) Pub. No.: US 2012/0302485 A1
(43) Pub. Date: Nov. 29, 2012

(54) Method and Composition for Removing Stains

(76) Inventor: Beth Chester, Dennis Port, MA (US)

(21) Appl. No.: 13/477,101

(22) Filed: May 22, 2012

Related U.S. Application Data
(60) Provisional application No. 61/488,875, filed on May 23, 2011.

(51) Int. Cl. C11D 7/60; B08B 5/04; B08B 1/00; C11D 10/06

(52) U.S. Cl. 510/199; 510/504; 510/380; 510/381; 510/367; 510/363; 510/109; 510/276; 510/278; 510/206; 510/240; 510/245; 510/481; 134/21; 134/6

(57) ABSTRACT

A method and composition for removing stubborn stains that includes the application of a mixture comprising alkyl dimethyl benzyl ammonium chlorides, bleach, and water. A major advantage of the method is that the composition solution is strong enough to remove stubborn stains from soft and hard surfaces and restore original appearance and scent to old fabrics, yet sufficiently mild to not damage delicate and colored fabrics or pose a threat to the person treating the stain.

### CROSS REFERENCE TO RELATED APPLICATION

This application takes priority from and claims the benefit of U.S. Provisional Application Ser. No. 61/488,875 filed on May 23, 2011, the contents of which are hereby incorporated by reference.

### BACKGROUND OF THE INVENTION

### Field of the Invention

The invention relates to products and methods for removing stains, and more particularly, to a composition and method that effectively eliminates hard-to-remove stains, blood, mold and dirt from soft fabric surfaces and hard painted wood, concrete or stucco surfaces. The invention also relates to a method for eliminating the damaging effect of bleach-containing solution on soft fabrics and hard composites.

Homemakers are constantly striving to improve the appearance of their home by redecorating, painting and replacing old furniture, carpets and window treatments. A composition product that has the capability of cleaning both soft materials and hard composites in order to give them a clean, fresh, vibrant and brand new appearance is extremely advantageous. Until presently, no single product or prior art patent has had the capability of removing mold, blood, and stains from soft and hard surfaces, with minimal effort.

### SUMMARY OF THE INVENTION

It is an object of the invention to provide a composition that is strong enough to remove stubborn coffee, tea and blood stains.

It is another object of the invention to provide a composition that is sufficiently mild enough so as to not damage the textile or fabric being applied to.

It is another object of the invention to provide a composition that is sufficiently mild enough so as to not harm or pose a risk of danger to the person treating the stain.

It is another object of the invention to provide a composition that is strong enough to remove stubborn stains while simultaneously not damaging the textile or fabric being applied to.

It is yet another object of the invention to provide a composition that is free from noxious odor.

It is another object of the invention to provide a composition that restores a new and clean smell to soft fabrics.

It is yet another object of the invention to provide a composition that be used for power washing the outside of a home, deck or other outdoor article or surface.

It is yet another object of the invention to provide a composition that can be combined with other cleaners, soaps and detergents for disinfecting, deodorizing or cleaning stubborn stains.

It is another object of the invention to provide a composition that is useful for both soft fabrics and hard surfaces, including but not limited to, wood, concrete, plastic, glass and stucco.

It is another object of the invention to provide a composition that is useful for removing stains on stainless steel better than using an S.O.S. brand pad.

This invention is a method and composition for removing stubborn stains that includes the application of a mixture comprising alkyl dimethyl benzyl ammonium chlorides, bleach, and water. A major advantage of the method is that the composition solution is strong enough to remove stubborn stains from soft and hard surfaces and restore original appearance and scent to old fabrics, yet sufficiently mild to not damage delicate and colored fabrics or pose a threat to the person treating the stain.

### DETAILED DESCRIPTION OF THE PREFERRED EMBODIMENTS

The invention is a composition and method that effectively eliminates stubborn stains, grease, blood, mold and dirt from soft fabric surfaces and hard painted wood, concrete or stucco surfaces. In addition, the method of the present invention is capable of eliminating the damaging effect of bleach-containing solution on soft fabrics and hard composites.

In the preferred embodiment, a stain removing composition comprises alkyl dimethyl benzyl ammonium chlorides, bleach, and water. Preferably, the stain removing composition comprises, in percentage weight about Alkyl (50% C14, 40% C12, 10% C16) Dimethyl Benzyl Ammonium Chlorides 1-2% (ADBAC), and bleach and water about 98-99%. Preferably, the bleach used is sodium hypochlorite, calcium hypochlorite, or sodium dichloroisocyanurate; but other known types of bleach, including but not limited to oxygen bleaches, may be used. It was very surprising to discover that weak bleach is effective for removing stubborn stains when used in combination with the above, and when applied to soft colored fabrics does not damage or bleach out the color in any way. It is noted that a variety of combinations and varying percentage weights may be possible.

The three or more components are mixed together in a container to form a cloudy mixture and then applied to the area of application for cleaning. Preferably, the components are mixed together in a spray container, but may be mixed in any kind of dispensing device. Unlike other compositions, which must be quickly removed from soft textile fabrics after application in order to prevent damage, the present invention does not need to be quickly removed. On the contrary, the present invention can migrate into fabric including seeping through the backing of carpet and dissolve into the backing without the need for using a vacuum or other sucking device to remove the composition quickly after application.

It is noted that the present method may include rinsing or removal of residual, but it is not necessary or required. When cleaning dirt or mold from a hard surface it may be advantageous after application to use a sponge or cloth to remove mold, grease, dirt and grime. However, after application to soft fabric materials, most stains will disappear on the spot without the need to wipe or remove excess residual.

Another embodiment of the present invention relates to a method of removing a stain from a textile (including a hard or soft fabric) comprising the steps of applying to a stained area of the textile the composition prepared by mixing alkyl dimethyl benzyl ammonium chlorides, bleach, and water. After the composition has been applied to the area of application it remains thereon for a pre-determined amount of time, which may include indefinitely. Under certain circumstances, the composition may be removed after a pre-determined amount of time using a suction device, such as a vacuum, or wiped away using a sponge or cloth. The process may be repeated several times until the stain is removed. Eventually, water may be applied to the area to dilute the composition and aid in the removal process.

It should be noted that it is known to use ammonia and hydrogen peroxide to remove stubborn carpet stains including those from coffee, tea and blood. While this known composition is effective, it results in a noxious and toxic odor. The present composition and method removes similar stains more effectively and simultaneously returns the textile to its original new scent. Thus, the present method allows use of the composition in large quantities and in all environments, including rooms that are not ventilated or include children and pets, eliminating the concern of bodily harm from fumes and skin contact.

The present invention is useful for removing stubborn stains, blood, mold and dirt from soft fabric surfaces like jeans, carpet and upholstered furniture and hard painted wood, plastic, tile, stainless steel, concrete, glass or stucco surfaces. Unlike many other products, the present invention cleans the stained surface and does not leave behind a film or residue that is common with many other cleaning products.

Further, the present combination is also available for mixture with other cleaning solutions for carpet, upholstery, soaps and detergents as a disinfecting agent, deodorizer or cleaning agent for removing stains on clothes, curtains or other fabrics.

Moreover, the present combination may be utilized as a cleaning agent for powering wash a home, deck or other outdoor article (such as an outdoor shower, trash cans or bins). For example, a clap board, wood home, or pressure treated deck can be power washed with the present combination to remove all mold, mildew and algae caused by damp ocean air and the like. Up until now, scrubbing the home by hand repeatedly was the only way to remove such tough stains.

In conclusion, herein is presented a composition and method that effectively eliminates stubborn stains, blood, mold and dirt from soft fabric surfaces and hard surfaces. The invention is illustrated by example in the drawing figures, and throughout the written description. It should be understood that numerous variations are possible, while adhering to the inventive concept. Such variations are contemplated as being a part of the present invention.

What is claimed is:

1. A composition for removing stains comprising:
a quantity of alkyl dimethyl benzyl ammonium chlorides;
a quantity of bleach; and
a quantity of water.

2. The composition for removing stains of claim 1, wherein the quantity of alkyl dimethyl benzyl ammonium chlorides is present in a range of 1-2% of the total weight of the composition.

3. The composition for removing stains of claim 1, wherein the quantity of bleach and the quantity of water is present in a range of 98-99% of the total weight of the composition.

4. The composition for removing stains of claim 1, wherein the quantity of bleach is selected from the group consisting of: sodium hypochlorite, calcium hypochlorite, sodium dichloroisocyanurate, and oxygen bleach.

5. A method of removing stains utilizing the composition of claim 1, comprising the steps of:
mixing a quantity of alkyl dimethyl benzyl ammonium chlorides, a quantity of bleach, and a quantity of water;
forming a cloudy mixture from the quantity of alkyl dimethyl benzyl ammonium chlorides, bleach, and water;
applying a quantity of the composition to a stained area; and
allowing the applied composition to remain on the stained area.

6. The method of removing stains of claim 5, further comprising the steps of:
removing the applied composition from the stained area.

7. The method of removing stains of claim 6, wherein the process of removing the applied composition is selected from the group consisting of: a suction device, a sponge, and a cloth.

8. The method of removing stains of claim 6, wherein the type of stain to be removed is selected from the group consisting of: stains, blood, mold, and dirt.

9. The method of removing stains of claim 6, wherein the surface of the stain to be removed is selected from the group consisting of: jeans, carpet, upholstered furniture, hard painted wood, plastic, tile, stainless steel, concrete, glass and stucco.

10. The method of removing stains of claim 6, further comprising the step of:
mixing the composition with a quantity of a second cleaning solution.

11. The method of removing stains of claim 10, wherein the second cleaning solution is selected from the group consisting of: soaps, detergents and deodorizers.
